(19) United States
(12) Patent Application Publication
(10) Pub. No.: US 2010/0012763 A1
(43) Pub. Date: Jan. 21, 2010

(54) SPOOLER

(76) Inventor: Robert Ernest Boardman, Queensland (AU)

Correspondence Address: KIRTON AND MCCONKIE, 60 EAST SOUTH TEMPLE,, SUITE 1800, SALT LAKE CITY, UT, 84111, US

(21) Appl. No.: 12/520,762

(22) PCT Filed: Dec. 5, 2007
(86) PCT No.: PCT/AU07/01870

§ 371 Date: Jun. 22, 2009

(30) Foreign Application Priority Data
Dec. 22, 2006 (AU) 2006907186

(51) Int. Cl. B65H 59/04; B65H 49/26; A01K 89/00; A01K 97/00

(52) U.S. Cl. 242/423.2

(57) ABSTRACT

A spooler having a base member and a shaft attached to the base member. The shaft has a longitudinal flat section at its free end and a D washer. A spring and a retaining nut are mounted on the free end of the shaft to retain and to brake the rotation of a spool. A low friction spacer is mounted on the shaft between the spool and the base member and a low friction spacer is mounted between the spool and the D washer.

### FIELD OF THE INVENTION

This invention relates to spoolers for winding lines onto reels and in particular for winding fishing lines onto fishing reels.

### BACKGROUND OF THE INVENTION

There is a long standing problem which occurs when lines are wound onto reels from the temporary spool on which they are supplied. If tension is not applied to the line as it is wound onto the reel the line is likely to be loose and can often come off the reel in tangled bunches traditionally called “grapes”. There are a number attempts to overcome this problem disclosed in patent documents.

U.S. D456,483 teaches a U shaped spooler which is attached to fishing rod and which holds the spool mounted on a shaft which extends between the arms of the U. One end of the shaft has a thumb grip and the other a thread which screws into a threaded hole in the opposite arm. However it is doubtful that an appropriate tension could be applied to the spool to prevent the above problem.

WO 91/13824 discloses a spooler system where the reel is mounted on a rotary casing which has vanes onto which jets of air are directed to induce rotation so as to maintain tension and to wind back any slack onto the reel. This is a sophisticated and costly device which is not suitable for simple spooling as is required for fishing lines.

Yet more complex systems are taught in U.S. Pat. No. 5,161,749 which is designed to wind thread at high speed, U.S. Pat. No. 4,156,509 which has a complicated wire tension controller and U.S. Pat. No. 1,490,512 which has a spooler cup tension device. None of these are convenient for use on location where fishing takes place.

### OBJECT OF THE INVENTION

It is therefore an object of the present invention to provide a spooler which is simple, effective and portable or at least provides a useful alternative to the prior art devices.

### STATEMENT OF THE INVENTION

According to the present invention a spooler comprises a base member, a shaft attached to the base member, the shaft having a longitudinal flat section at its free end and a D washer, a spring and a retaining nut mounted on the free end of the shaft to retain and to brake the rotation of a spool.

Preferably the base member comprises an angle bracket with means for securing it to a platform.

Preferably the flange of the angle bracket has holes to receive a U bolt for attachment to a pipe.

Preferably there is a low friction spacer mounted on the shaft between the spool and the angle bracket.

Preferably there is a low friction washer between the spool and the D washer Preferably the low friction spacer and washer are made from nylon.

Preferably the retaining nut is knurled.

Preferably the spring is a steel helical spring.

Alternatively the spring can be a block of elastic material retained on the shaft.

In an alternative version the base member has a guide which guides the line allowing it to be drawn at an angle from the plane of rotation of the spool.

### BRIEF DESCRIPTION OF THE DRAWINGS

An embodiment of the invention is now described by way of example only with reference to the accompanying drawings in which:

FIG. 1 is a cross sectioned elevation of a bracket with spooler axle

FIG. 2 is an elevation of the spooler with spool mounted

FIG. 3 is an exploded elevation of the spooler of FIG. 2

FIG. 4 is an isometric view of FIG. 3

FIG. 5 is an exploded view of a spooler with an alternative bracket

FIG. 6 is an assembled side view of the alternative of FIG. 5 and

FIG. 7 is an isometric view of FIG. 5

### DETAILED DESCRIPTION OF THE INVENTION

The base of the spooler shown in FIG. 1 consists of an angle bracket 1 with holes drilled in its vertical flange for mounting with a U bolt for example, to a bull bar, or with other securing means to a suitable support. Shaft 3 screws into a threaded hole in the upper flange of bracket I and retains fibre washer 2 and stainless steel cone 4 against bracket 1.

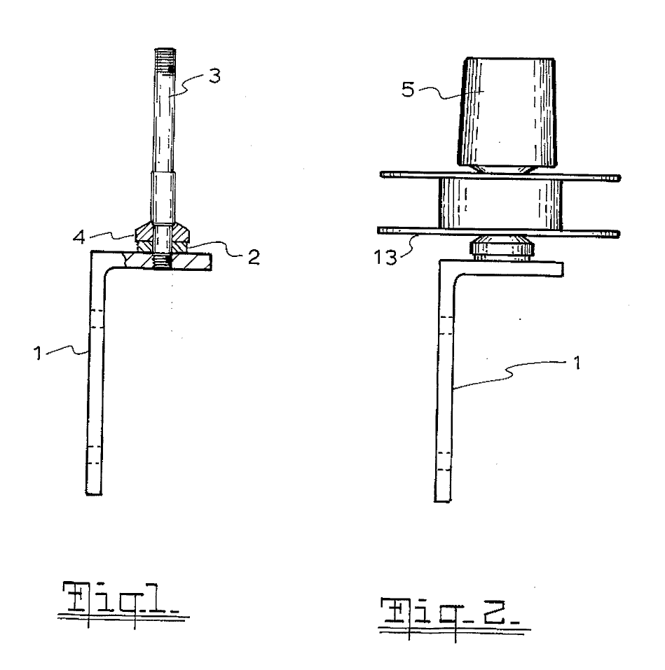

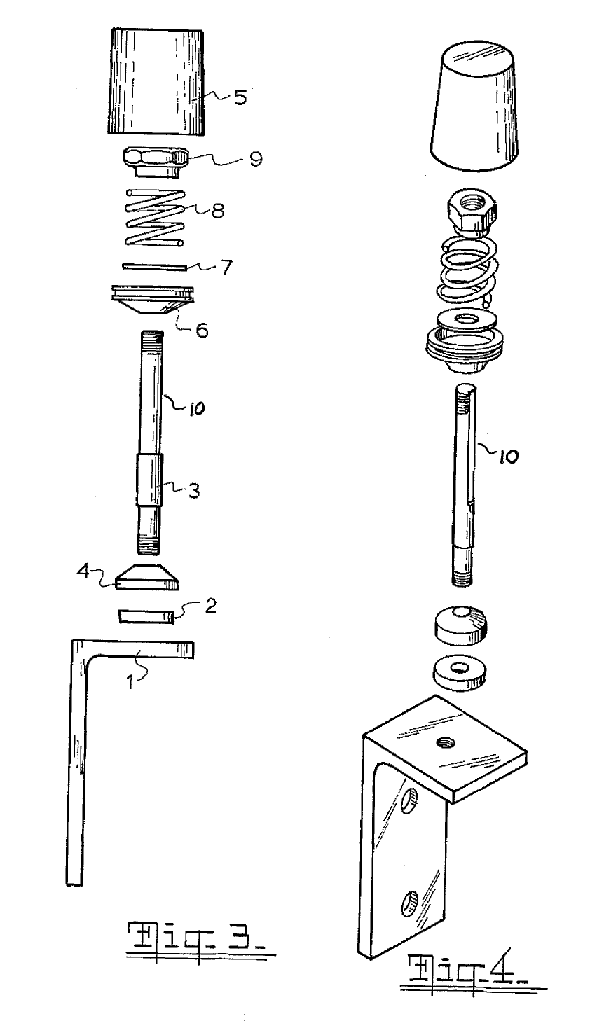

FIG. 2 shows spool 13 mounted on shaft 3 and retained by nylon cone 6, stainless steel D washer 7, helical spring 8 and nut 9 which are revealed in FIG. 3 and FIG. 4. Shaft 3 has a longitudinal flat section 10 which receives D washer 7 located between nylon cone 6 and helical spring 8. Nut 9 is tightened to compress spring 8 which thereby brakes rotation of spool 13. Plastic cap 5 snaps over cone 6 and shields the braking assembly.

Nylon cone 6 rotates with spool 13 but D washer 7 and spring 8 are held fixed on shaft 3 by nut 9. Accordingly the required degree of tension can be applied to spool 13 by tightening nut 9 which maintains the tension on cone 6 and spool 13 as they rotate. Ideally nut 9 is tightened until the tension in the line is marginally less than the breaking strain of the line. This results in the line being tightly wound onto the fishing reel so that it is unlikely to come off in tangled bunches.

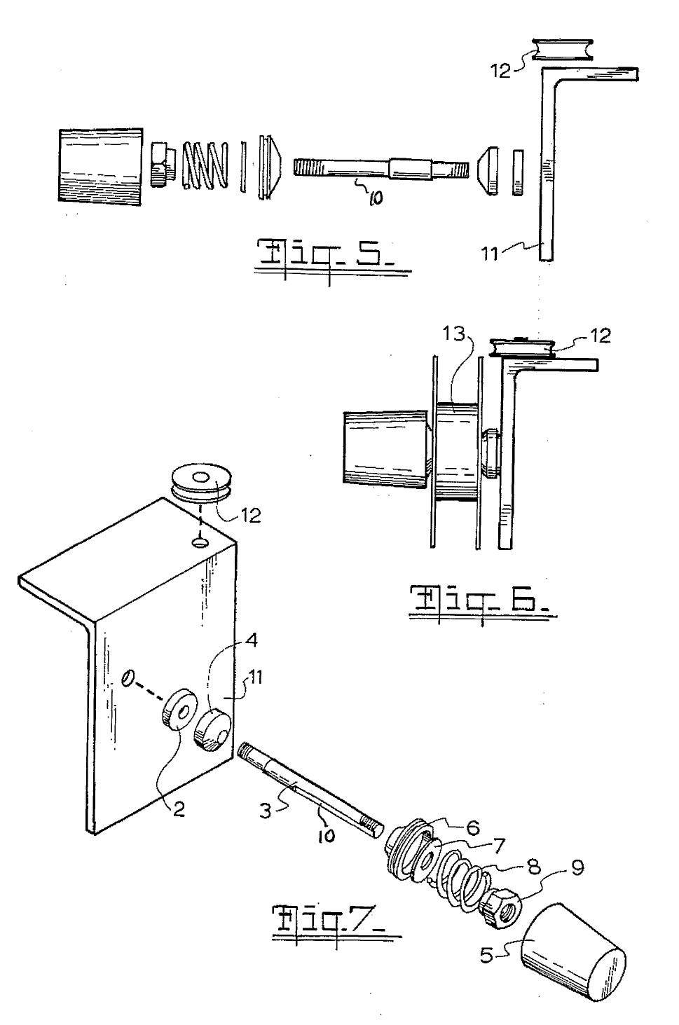

FIGS. 5, 6 and 7 show an alternative version of the spooler in which axle 3 is mounted on the face of angle bracket 11 and nylon guide 12 is mounted on the flange of bracket 11 with its axis at right angles to axle 3. Accordingly the fishing line can be drawn off spool 13 at right angles to the plane of rotation of spool 13 This enables alternative mounting arrangements for spooling.

### VARIATIONS

It will be realized that the foregoing has been given by way of illustrative example only and that all other modifications and variations as would be apparent to persons skilled in the art including mechanical equivalents are deemed to fall within the broad scope and ambit of the invention as herein set forth. For example, the helical spring may be replaced by a block of elastic material retained on the shaft.

Throughout the description and claims of this specification the words “comprise” and variations of that word such as “comprises” and “comprising” are not intended to exclude other additives components integers or steps.

1. A spooler consists of a base member, a shaft attached to the base member, the shaft having a longitudinal flat section at its free end and a D washer, a spring and a retaining nut mounted on the free end of the shaft to retain and to brake the rotation of a spool, a low friction spacer mounted on the shaft between the spool and the base member and a low friction spacer between the spool and the D washer.

2. The spooler of claim 1 in which the base member comprises an angle bracket with means for securing it to a platform.

3. The spooler of claim 2 in which the flange of the angle bracket has holes to receive a U bolt for attachment to a pipe.

4. (canceled)

5. (canceled)

6. The spooler of claim 1 in which the low friction spacers are made from nylon.

7. The spooler of claim 1 in which the retaining nut is knurled.

8. The spooler of claim 1 in which the spring is a steel helical spring.

9. The spooler of claim 1 in which the spring is a block of elastic material retained on the shaft.

10. The spooler of claim 1 which also has a guide allowing a line to be drawn from the spooler at an angle to the plane of rotation of the spool.
